(19) United States
(12) Patent Application Publication
(10) Pub. No.: US 2026/0094918 A1
(43) Pub. Date: Apr. 2, 2026

(54) BATTERY HOLDER AND A BATTERY PACK

(71) Applicant: Ford Global Technologies, LLC, Dearborn, MI (US)

(72) Inventors: Fei Gao, Nanjing (CN); Robin Zhou, Nanjing (CN); Larry Wang, Nanjing (CN)

(21) Appl. No.: 19/335,314

(22) Filed: Sep. 22, 2025

(30) Foreign Application Priority Data
Sep. 30, 2024 (CN) 202411391188.7

(51) Int. Cl. H01M 50/262; B60L 50/64; B60L 58/26; H01M 10/613; H01M 10/625; H01M 10/647; H01M 10/6554; H01M 10/658; H01M 50/211; H01M 50/249

(52) U.S. Cl. CPC H01M 50/262; H01M 10/613; H01M 10/625; H01M 10/647; H01M 10/6554; H01M 10/658; H01M 50/211; H01M 50/249; B60L 50/64; B60L 58/26; H01M 2220/20

(57) ABSTRACT

The present disclosure provides a battery pack, comprising: a first battery cell; a second battery cell; and a holder having a main body portion that extends between opposite surfaces of the first battery cell and the second battery cell and a supporting portion that extends from the main body portion to a side portion of the first battery cell and/or the second battery cell, wherein the supporting portion includes a groove extending on its outer surface. Through the technical solution of the present disclosure, the battery cells can be effectively fixed, space can be saved, and overall performance and structural strength of the battery pack can be enhanced.

### CROSS-REFERENCE TO RELATED APPLICATIONS

This disclosure claims priority to Chinese Patent Application No. 202411391188.7, which was filed on 30 Sep. 2024 and is incorporated herein by reference in its entirety.

### TECHNICAL FIELD

The present disclosure relates to the field of vehicles, and more specifically, to a battery holder and a battery pack.

### BACKGROUND

Battery packs are usually included in electrified vehicles. As users have increasingly high demands for vehicle performance, range, etc., higher requirements are consequently put forward for energy density, range, and durability of the battery packs. The battery pack usually includes multiple battery cells, and the multiple battery cells are usually arranged in a battery pack casing in configurations such as modules, arrays or other arrangements. How to enhance the capacity and overall performance of the battery packs is a research hotspot in this field.

In the prior art, there are various arrangement designs of the battery cells. For example, CN217387305U provides a battery module, in which a cell assembly includes multiple cells and multiple heat dissipation frames. Spaces for accommodating the cells are formed between the heat dissipation frames, and a support structure is further included above the heat dissipation frames to guide and support cell tabs.

### SUMMARY

The present disclosure summarizes aspects of embodiments and should not be used to limit the claims. Other implementations are contemplated in accordance with the techniques described herein, as will be apparent to those skilled in the art upon examination of the following drawings and detailed description, and such implementations are intended to be within the scope of this application.

The inventors of this application recognize that there is a need to provide a battery pack structure, in which battery cells are fixed by a holder.

According to an aspect of the present disclosure, there is provided a battery pack, comprising:
a first battery cell;
a second battery cell; and
a holder having a main body portion that extends between opposite surfaces of the first battery cell and the second battery cell, and a supporting portion that extends from the main body portion to a side portion of the first battery cell and/or the second battery cell,
wherein the supporting portion includes a groove extending on its outer surface.

According to an embodiment of the present disclosure, the first battery cell and the second battery cell respectively include a first surface and a second surface facing each other along a first direction, the first surface and the second surface are in contact with the main body portion, and the side portion of the first battery cell along a second direction is oriented opposite to or in contact with an inner surface of the supporting portion.

According to an embodiment of the present disclosure, the main body portion extends from a top of the first battery cell to a bottom of the first battery cell along a surface of the first battery cell.

According to an embodiment of the present disclosure, the main body portion is sheet-shaped, and the main body portion includes a plurality of notches or through openings.

According to an embodiment of the present disclosure, the supporting portion of the holder extends to cover side portions of the first battery cell and the second battery cell.

According to an embodiment of the present disclosure, the battery pack further comprises a third battery cell adjacent to the first battery cell, wherein the supporting portion extends to cover side portions of the first battery cell and the third battery cell.

According to an embodiment of the present disclosure, the battery pack further comprises a plurality of battery cells arranged along a first direction to form a battery module; and the battery pack comprises a heat insulation plate at least partially covering an upper surface of the battery module, and the heat insulation plate is in contact with the supporting portion of the holder.

According to an embodiment of the present disclosure, a plurality of holders are provided, and a preset gap is formed between the supporting portions of adjacent holders.

According to an embodiment of the present disclosure, the supporting portion of the holder includes the groove and an adhesive overflow groove formed by a protrusion, and/or the groove and an adhesive overflow groove recessed from an upper surface of the supporting portion;

wherein the heat insulation plate includes an opening portion that is shaped to match the protrusion.

According to an embodiment of the present disclosure, the adhesive overflow groove is adjacent to the groove and extends along a direction of the groove.

According to an embodiment of the present disclosure, the battery pack further comprises a cooling plate disposed below one or more of battery modules, wherein the cooling plate is connected to a bridge bracket between adjacent battery modules, the bridge bracket has feet and a raised support body between the feet, and the feet are fixedly or detachably connected to a tray.

According to an embodiment of the present disclosure, the tray has an upper flange, a first side wall, and a first bottom wall;
the tray further includes a reinforcing bracket, the reinforcing bracket is connected to the upper flange and the first bottom wall at a distance from the first side wall, and the reinforcing bracket has a second side wall and a second bottom wall respectively having a first through-hole and a second through-hole.

According to an embodiment of the present disclosure, the battery pack further comprises:
an attachment bracket having connecting arms and an arched portion between the connecting arms;
wherein the attachment bracket is adjacent to the first through-hole and connected to the second side wall through the connecting arms; and wherein the first through-hole is oriented opposite to the arched portion to form a gap therebetween.

According to another aspect of the present disclosure, there is provided a battery holder, comprising:
a main body portion configured to extend on a first surface of a first battery cell;
a supporting portion extending from the main body portion; and
a groove extending along an upper surface of the supporting portion.

According to an embodiment of the present disclosure, the main body portion extends between the first surface of the first battery cell and a second surface of a second battery cell and is in contact with the first surface and the second surface, the first surface and the second surface are oppositely facing surfaces, and the supporting portion extends from the main body portion to a side portion of at least one battery cell, and the supporting portion has a lower surface that is oriented opposite to or in contact with a side portion of at least one of the first battery cell and the second battery cell.

According to an embodiment of the present disclosure, the main body portion is sheet-shaped, and the main body portion includes a plurality of notches or through openings.

According to an embodiment of the present disclosure, the supporting portion of the holder extends to cover side portions of at least two adjacent battery cells, and the holder has a T-shaped, L-shaped, or I-shaped cross-section.

According to an embodiment of the present disclosure, the supporting portion includes the groove and an adhesive overflow groove formed by a protrusion; and/or
the supporting portion includes the groove and an adhesive overflow groove recessed from the upper surface of the supporting portion.

According to an embodiment of the present disclosure, the adhesive overflow groove is adjacent to the groove and extends along a direction of the groove.

According to yet another aspect of the present disclosure, there is provided a vehicle having a battery pack, the battery pack comprising:
a first battery cell;
a second battery cell; and
a holder having a main body portion that extends between opposite surfaces of the first battery cell and the second battery cell, and a supporting portion that extends from the main body portion to a side portion of the first battery cell and/or the second battery cell, wherein the supporting portion includes a groove extending on its outer surface.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

For a better understanding of the present disclosure, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further in the figures, like referenced numerals refer to like parts throughout the different figures.

FIG. 1 is a schematic diagram of a vehicle according to an embodiment of the present disclosure;

FIG. 2 is a schematic diagram of a battery pack according to an embodiment of the present disclosure;

FIG. 3 is a schematic diagram of the battery pack with a top cover removed according to an embodiment of the present disclosure;

FIG. 4 is a cross-sectional view of the battery pack in FIG. 2 along a width direction;

FIG. 5 is a schematic diagram showing the cooperation between battery cells and a battery holder according to an embodiment of the present disclosure;

FIG. 6 is a schematic diagram showing the structure of the battery holder according to an embodiment of the present disclosure;

FIG. 7 is a schematic diagram showing the cooperation structure between a supporting portion of the battery holder and a heat insulation plate according to an embodiment of the present disclosure;

FIG. 8 is a schematic diagram showing the connection structure between a bridge bracket and a battery module according to an embodiment of the present disclosure;

FIG. 9 is a schematic diagram showing the connection structure between a reinforcing bracket and an attachment bracket according to an embodiment of the present disclosure;

FIG. 10 is a schematic diagram showing the connection structure between the reinforcing bracket, the attachment bracket and a tray according to an embodiment of the present disclosure;

FIGS. 11A and 11B are schematic diagrams showing the structure of the battery holder according to a second and third embodiments of the present disclosure; and

FIG. 12 is a schematic diagram of the battery holder according to a fourth embodiment of the present disclosure.

### DETAILED DESCRIPTION

Embodiments of the present disclosure are described below. However, it is to be understood that the disclosed embodiments are merely examples and other embodiments may take various and alternative forms. The figures are not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure. As will be understood by those of ordinary skill in the art, various features shown and described with reference to any one figure may be combined with features shown in one or more other figures to produce embodiments not expressly shown or described. The combinations of features shown herein provide representative embodiments for typical disclosures. However, various combinations and modifications of the features consistent with the teachings of the present disclosure may be desired for certain particular applications or implementations.

In this application document, when an element or part is referred to as being “on . . . ”, “bonded to”, “connected to”, or “coupled to” another element or part, the element or part can be directly on another element or part, can be bonded, connected or coupled to another element or part, or there may be intervening elements or parts. In contrast, when an element is referred to as being “directly on . . . ”, “directly bonded to”, “directly connected to”, or “directly coupled to” another element or part, the intervening elements or parts may not be present. Other words used to describe the relationship between elements should be interpreted in a like fashion.

As mentioned in the background above, the inventors of the present application recognize that in the prior art, the battery packs adopt an array design that allows them to be mounted on battery trays. Therefore, in some designs, it is necessary to arrange a plurality of independent battery modules. These battery modules are usually mounted on the tray via beam structures after packaging, and a large number of busbars and bus are required to connect them to each other. However, arranging more beam structures to fix the battery modules lead to increased complexity and low effective space utilization. The inventors of the present application provide a battery holder and a battery pack using the same in one or more embodiments.

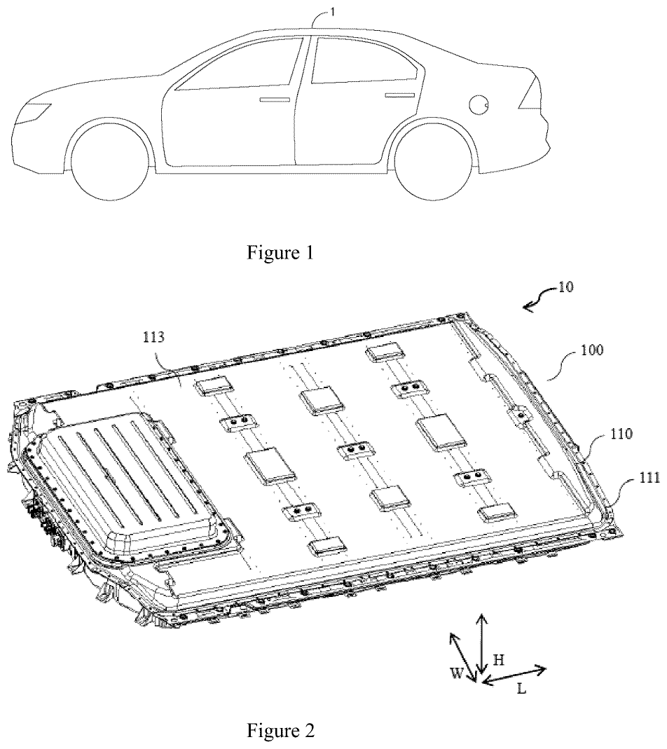

FIG. 1 is a schematic diagram of a vehicle 1 according to an embodiment of the present disclosure. The vehicle 1 may refer to any means of transportation that includes a battery pack; for examples, may include, but are not limited to, fossil fuel vehicles, electric vehicles (such as plug-in hybrid electric vehicles (PHEVs), full hybrid electric vehicles (FHEVs), mild hybrid electric vehicles (MHEVs), or battery electric vehicles (BEVs)), and may even include ships, aircraft, and the like. The vehicle 1 may include components related to mobility, such as an engine, an electric motor, a transmission, a suspension, a drive shaft, and/or wheels. The vehicle 1 may be non-autonomous, semi-autonomous (e.g., some conventional movement functions are controlled autonomously by the vehicle), or autonomous (e.g., movement functions are controlled autonomously by the vehicle without direct user input).

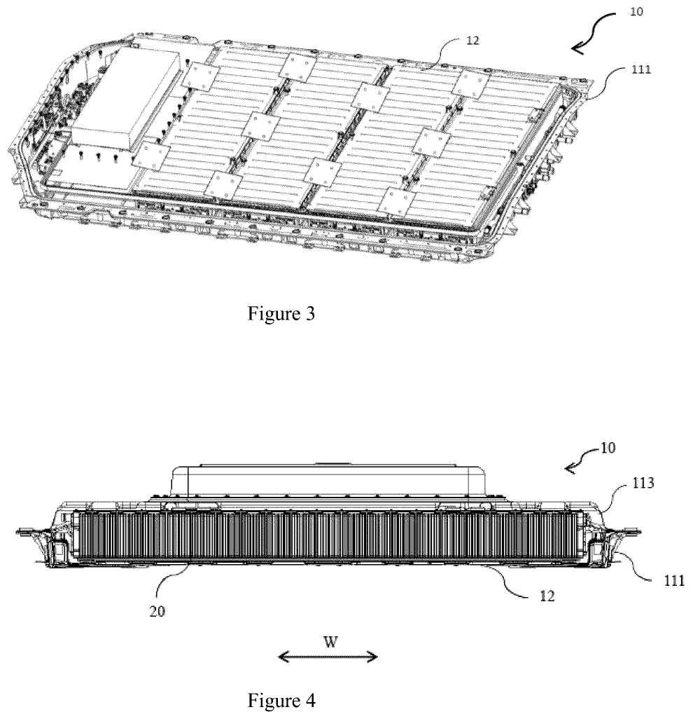

FIGS. 2 and 3 are schematic diagrams of a battery pack 10 according to an embodiment of the present disclosure. Referring to FIGS. 2 and 3, the battery pack 10 includes a battery case assembly 100 and a battery module 12 accommodated in the battery case assembly 100. The battery case assembly 100 may include a case 110 and various possible functional attachments. The case 110 may include a tray 111 for supporting the battery module 12 and a top cover 113 for covering the battery module 12; the tray 111 and the top cover 113 together define a receiving cavity for accommodating the battery module 12. The tray 111 may have a box-shaped structure with a top opening, including a bottom wall and one or more side walls extending upward from a peripheral side of the bottom wall. The top cover 113 covers the top opening of the tray 111; the top cover 113 may have a box-shaped structure with a bottom opening, including a top wall and one or more side walls extending downward from a peripheral side of the top wall. The top opening of the tray 111 is butted with the bottom opening of the top cover 113, so that the case 110 encloses a generally sealed receiving cavity. Flanges may be provided at the top opening of the tray 111 and the bottom opening of the top cover 113, and matching connection structures are disposed on the flanges to realize the connection between the tray 111 and the top cover 113. Those skilled in the art will understand that the top cover and the tray may also have different designs; for example, the tray may only have a bottom, while the top cover may have side walls extending toward the tray and connected to the tray, as long as the two can form a space for accommodating battery cells. The case 110 defines a length direction L, a width direction W, and a height direction H. The battery module 12 may include a plurality of battery cells 11 arranged in an array; the plurality of battery cells 11 may be arranged in multiple rows, the plurality of battery cells 11 in each row are arranged along the width direction W of the case 110, and the multiple rows of battery cells are arranged along the length direction L of the case 110. The battery module 12 may further include a battery management unit for controlling the charging and discharging of the plurality of battery cells 11. In one or more other implementations, the battery cells 11 may also be arranged along the length direction L.

The battery pack 10 may have a variety of application scenarios. In the embodiment of the present disclosure, the battery pack 10 is applied to a vehicle. The length direction L, width direction W, and height direction H of the case 110 may correspond to a longitudinal direction (front-rear direction), a lateral direction, and a height direction of the vehicle, respectively.

Those skilled in the art will understand that although in the above exemplary embodiments, the battery case assembly 100 is shown to accommodate the battery module 12, thereby serving as a case assembly constituting a complex battery pack 10, in alternative embodiments, the battery case assembly 100 may also be used to accommodate the battery cells, thereby serving only as a case assembly constituting a simple battery unit.

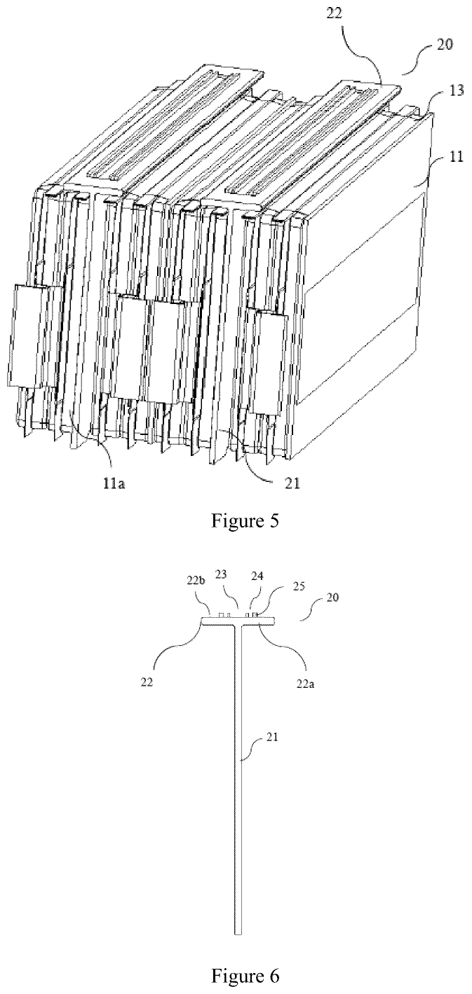

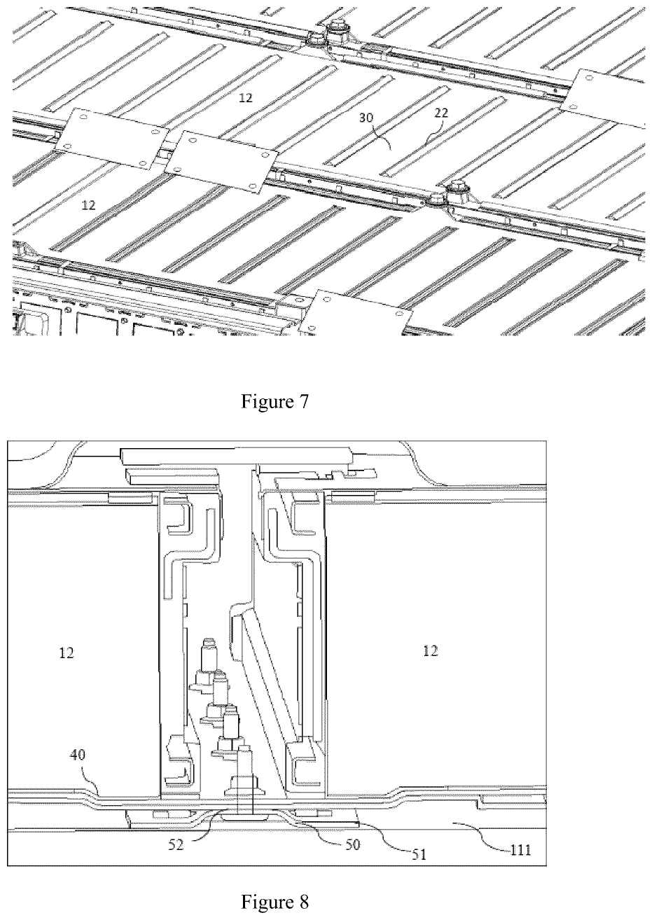

Referring to FIG. 4, in an illustrative embodiment of the present disclosure, the plurality of battery cells 11 in the battery pack 10 are arranged along the width direction W of the case 110 to form the battery module 12. The battery module 12, as a whole, is accommodated in the receiving cavity formed by the tray 111 and the top cover 113. As can be seen from FIG. 4 and FIG. 5, in this embodiment, a holder 20 is provided between two adjacent battery cells 11. As shown in FIG. 6, the holder 20 includes a main body portion 21 and a supporting portion 22. The main body portion 21 can extend along a first surface 11a of at least one battery cell 11. It should be understood that the main body portion 21 can also extend along other suitable surfaces of the battery cell 11, such as end portions. In the embodiments shown in FIGS. 3 to 6, the main body portion 21 extends between two battery cells 11, while the supporting portion 22 extends to a side portion (that is top) of at least one battery cell 11. As can be seen from FIG. 5, in this illustrative embodiment, the supporting portion 22 extends along the length direction L of the main body portion 21; and as can be seen from the cross-section shown in FIG. 6, the supporting portion 22 extends transversely to the main body portion 21 from an upper end of the main body portion 21. In other words, in this illustrative embodiment, the supporting portion 22 can extend at least partially along an upper surface perpendicular to the main body portion 21.

In the illustrative embodiments shown in FIGS. 3 to 5, the main body portion 21 has an integral sheet-shaped structure. In some embodiments, the main body portion 21 may include one or more openings passing through the main body portion 21. In other embodiments, the one or more openings of the main body portion 21 may be offset along the height direction H, which reduces weight while having little or no influence on the load-bearing capacity in the H direction; in addition, the one or more openings can increase the bonding force when adjacent battery cells are connected by adhesion. In other embodiments, the main body portion 21 may further include one or more depressions or protrusions; similar to the above, a rough connection interface may also help increase the bonding force. Those skilled in the art will understand that the main body portion 21 may also be in other structural forms that can be inserted between two adjacent battery cells 11 (e.g., strip-shaped structures, grid-shaped structures, comb-shaped structures, etc.); and in still other embodiments, the sheet-shaped main body portion 21 may have no openings or notches.

In the illustrative embodiments shown in FIGS. 3 to 5, when the holder 20 is disposed in the battery module 12, the main body portion 21 extends between opposite surfaces of two adjacent battery cells 11 and extends from the top to the bottom of the battery cells 11, thereby covering the entire surface of the battery cells 11 along the length direction L. The supporting portion 22 extends from the main body portion 21 to side portions 13 of the two adjacent battery cells 11, and its extension in the width direction W does not exceed the length of the side portions 13 of the battery cells 11. The holder 20 can be formed from a polymer material with heat insulation properties (including but not limited to flame-retardant polyolefins, polycarbonate, polystyrene, polyurethane foam) through various suitable processing techniques, such as injection molding, extrusion, etc. In this way, when the holder 20 is applied to the battery module 12, it can play the roles of support and thermal insulation. It should be understood that other non-polymer flame-retardant materials can also be used for the holder 20. In the illustrative embodiments shown in FIGS. 3 to 5, the supporting portion 22 has an inner surface 22a that is opposite to the side portion 13 of the battery cell 11. In another embodiment of the present disclosure, the inner surface 22a of the supporting portion 22 may abut against the side portion 13 of the battery cell 11.

In the illustrative embodiments shown in FIGS. 3 to 5, the holder 20 extends along the entire height direction H of the battery cell 11. Those skilled in the art will understand that in other embodiments of the present disclosure, only part of the main body portion 21 may extend entirely along the above-mentioned height direction H. In addition, the main body portion 21 may also extend only a certain distance in the height direction H without extending from the top to the bottom of the battery cell 11; the inner surface 22a of the supporting portion 22 of the main body portion 21 abuts against the side portion 13 of the battery cell 11, so that the holder 20 is supported by the battery cell 11.

In one or more embodiments of the present disclosure, an adhesive (including but not limited to structural adhesive, thermal conductive adhesive, etc.) may be coated on the main body portion 21, so that the surfaces facing each other between the main body portion 21 and the battery cell 11 are abutted and bonded together. Wherein, in the above-mentioned one or more embodiments, part of the adhesive can be contained in the openings that passes through the main body portion 21; and this not only bonds the main body portion 21 to the surface of the battery cell 11, but also bonds the opposite surfaces of two adjacent battery cells 11 through the through openings, thereby further enhancing the integrity and structural strength of the battery module 12.

In another embodiment of the present disclosure, the main body portion 21 may have notches provided on its sheet-shaped surface, and these notches do not pass through the main body portion. The provided notches can accommodate adhesive to increase the bonding strength, thereby achieving a more secure bond between the opposite surface of the main body portion 21 and the battery cell 11.

Referring to FIG. 6, in this illustrative embodiment, a groove 23 is provided on an outer surface 22b of the supporting portion 22 of the holder 20. In one embodiment, the holder 20 further includes an adhesive overflow groove 24 adjacent to the groove 23 and extending along an extension direction of the groove 23. In this embodiment, the groove 23 and the adhesive overflow groove 24 are formed by a protrusion 25. In one embodiment, the groove 23 may extend entirely along the W direction. Alternatively, the groove 23 and the adhesive overflow groove 24 may also be formed by forming recessed portions on the outer surface of the supporting portion 22. During the assembly process of the battery pack 10, the adhesive can be applied into the groove 23, and the holder 20 is bonded to an inner surface of the top cover 113 of the battery pack 10 through the adhesive, thereby improving the overall structural strength of the battery pack 10. During the bonding process, the inner surface of the top cover 113 abuts against the groove 23, causing part of the adhesive to overflow from the groove 23; the overflowed adhesive is accommodated by the adhesive overflow groove 24 adjacent to the groove 23 and also forms an additional bond with the top cover 113, which increases the area of the bonded part and enhances the bonding strength. Those skilled in the art will understand that in some embodiments, the holder 20 may not be directly bonded to the top cover 113; instead, a heat insulation plate (e.g., a mica plate) may be bonded to the side of the holder 20 where the groove 23 is located.

In another embodiment, the holder 20 may be arranged in an inverted manner, such that the outer surface of the supporting portion 22 is disposed towards the bottom of the battery pack 10, the holder 20 is bonded to the bottom structure of the battery pack 10 (including but not limited to the inner surface of the tray 111 or a cooling plate) through the groove 23 and the adhesive overflow groove 24 on the supporting portion 22, thereby forming a reinforced connection between the battery cells 11 fixed by the holder 20 and the bottom structure of the battery pack 10.

Furthermore, in yet another embodiment of the present disclosure, the holder 20 may also be configured as end plates on both sides of the battery module 12. Similar to the above embodiments, this end plate structure also includes a supporting portion, and the supporting portion has an outer surface that is equally provided with a groove and an adhesive overflow groove for accommodating adhesive. This allows the end plates to be bonded to the top cover 113 via the groove and adhesive overflow groove on the outer surface of their supporting portions, forming a reinforced integral structure. Unlike the above embodiments, however, the end plates are used to clamp the entire battery module 12—specifically, each end plate only abuts against the surface of one battery cell 11 along the length direction L and does not insert between two adjacent battery cells 11.

In another embodiment of the present application, the holder 20 may also be configured as side plates on both sides of the battery module 12. The side plates may extend along side surfaces of multiple battery cells in the W direction as shown in the figures. Similar to the above embodiments, this side plate structure also includes a supporting portion, and the supporting portion has an outer surface that is equally provided with a groove and an adhesive overflow groove for accommodating adhesive. This allows the side plates to be bonded to the top cover 113 via the groove and adhesive overflow groove on the outer surface of their supporting portions, forming a reinforced integral structure. The difference from the above embodiments lies in that the side plates are used to clamp the entire battery module 12; in other words, each side plate may abut against the surface of one battery cell 11 along the W direction and does not insert between two adjacent battery cells 11. In one or more other implementations, the battery pack 10 may include supports and/or separators extending along the height direction H. These supports and/or separators may also include a main body portion and a supporting portion, and there may be no clear boundary between the main body portion and the supporting portion of these supports and/or separators. The supporting portion may be a natural extension of the main body portion along the height direction H. The outer surface of the supporting portion of the supports and/or separators is also provided with a groove and an adhesive overflow groove for accommodating adhesive, enabling the supports or separators to be bonded to the top cover 113 via the groove and adhesive overflow groove on the outer surface of their supporting portions, thus forming a reinforced integral structure.

In this embodiment, as shown in FIG. 5, the battery module 12 has a plurality of holders 20. A preset gap is provided between the supporting portions 22 of adjacent holders 20 to facilitate the heat insulation plate covering the top of the battery module 12 to abut against the supporting portions 22 of the plurality of holders 20. Referring to FIG. 7, in this embodiment, when the heat insulation plate 30 entirely covers the top of the battery module 12, the heat insulation plate 30 is provided with a plurality of openings that are shaped to match the protrusions 25, so that the protrusions 25 plays a role in positioning the heat insulation plate 30 and also the heat insulation plate 30 can be supported by the supporting portions 22 of the holders 20. In this embodiment, the heat insulation plate 30 may be a mica plate. In some embodiments, along the H direction, the thickness of the heat insulation plate 30 corresponds to the thickness of the protrusions 25. In other embodiments, the thickness of the protrusions 25 is greater than that of the heat insulation plate 30. When the thickness of the protrusions 25 is greater than that of the heat insulation plate 30, while the heat insulation plate 30 covers the top of the battery module 12, the protrusions 25 can pass through the openings on the heat insulation plate 30 and expose above the heat insulation plate 30, facilitating the operator to position the heat insulation plate 30. In addition, the protrusions 25 with a thickness greater than that of the heat insulation plate 30 can more easily abut against the top cover 113, thereby completing the bonding with the top cover 113 when the groove 23 contains adhesive.

As shown in FIG. 8, in an illustrative embodiment, a cooling plate 40 may be disposed below a plurality of battery modules 12. The cooling plate 40 is connected to the bottom of the tray 111 via a bridge brackets 50 below adjacent battery modules 12. The bridge bracket 50 has feet 51 symmetrically distributed on both sides and a raised support body 52 between the two feet 51. In this embodiment, the feet 51 are fixedly connected to the bottom of the tray 111 by welding, and the cooling plate 40 is connected to the support body 52 via fasteners, so that the weight of the battery module 12 can be supported by the bridge bracket 50, and the cooling plate 40 can be more stably disposed below the battery module 12 through the fastener. Those skilled in the art will understand that in other embodiments of the present disclosure, the feet 51 may have an asymmetric structure and may also be detachably connected to the bottom of the tray 111 via fasteners. Additionally, the cooling plate 40 is not limited to one or more of metal cooling plates, finned liquid-cooled plates, and flow-channel liquid-cooled plates.

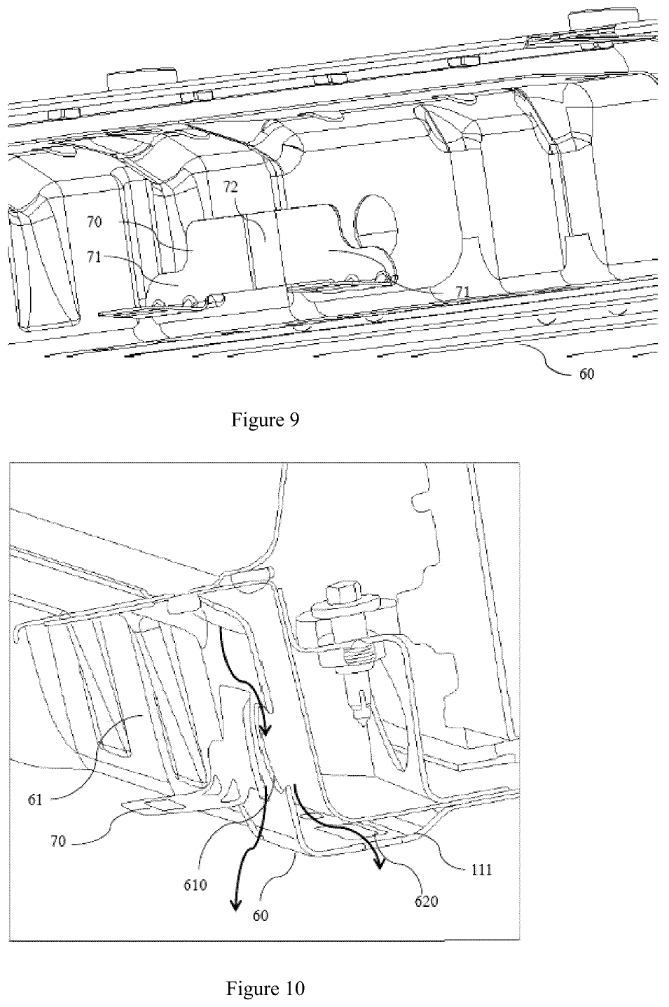

Next, referring to FIGS. 9 and 10, in an illustrative embodiment, the tray 111 is further provided with a reinforcing bracket 60. The reinforcing bracket 60 is connected from a flange of the tray 111 to the outer surface of the bottom. A side wall 61 of the reinforcing bracket 60 is spaced apart from the side wall 112 of the tray 111, and a first through-hole 610 and a second through-hole 620 are respectively provided in the side wall 61 and the bottom of the reinforcing bracket 60. In this illustrative embodiment, an attachment bracket 70 is mounted on the side wall 61 of the reinforcing bracket 60. The attachment bracket 70 has two symmetrically distributed connecting arms 71 and an arched portion 72 between the two connecting arms. When the attachment bracket 70 is connected to the outer surface of the side wall 61 of the reinforcing bracket 60 via the two connecting arms 71, the first through-hole 610 and the arched portion 72 are positioned opposite each other, forming a gap between the first through-hole 610 and the arched portion 72. During the electrophoretic treatment of the tray 111 and the reinforcing bracket 60, the inner surface of the arched portion 72 of the attachment bracket 70 can guide the flow of the electrophoretic fluid (as indicated by the arrows in FIG. 9), facilitating the electrophoretic fluid to pass through the first through-hole 610 via the gap into the space between the tray 111 and the reinforcing bracket 60, thereby forming a uniform anti-corrosion coating on both the surfaces of the tray 111 and the reinforcing bracket 60. At the same time, the second through-hole 620 can also act as a drain hole to allow the electrophoretic fluid to flow out. Furthermore, after the battery pack 10 is applied to a vehicle, the attachment bracket 70 can also function as a flow guide structure, allowing liquid on the battery pack to flow out through the attachment bracket 70, the first through-hole 610, and the second through-hole 620, thereby preventing liquid from accumulating on the structure of the battery pack 10.

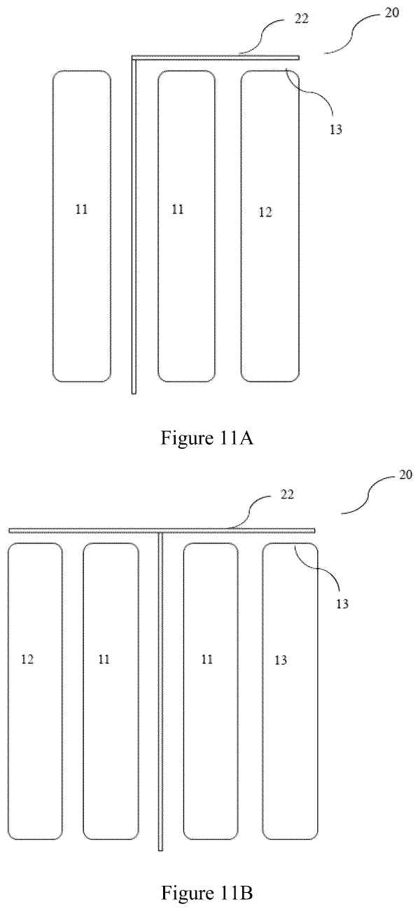

Next, refer to FIG. 11A, which shows a second embodiment of the present disclosure. In this embodiment, the supporting portion 22 of the holder 20 extends from the upper end of the main body portion 21 toward one side, thereby covering both the side portion 13 of one of the two adjacent battery cells 11 separated by the main body portion 21 and the side portion 13 of a third battery cell 11 adjacent to this battery cell 11. It will be understood that, similar to this embodiment, in other embodiments, the supporting portion 22 may further extend in one direction to cover the side portions 13 of more battery cells 11.

Continue to refer to FIG. 11B, which shows a third embodiment of the present disclosure. In this embodiment, the supporting portion 22 of the holder 20 not only covers the side portions 13 of the two adjacent battery cells 11 separated by the main body portion 21 but also further covers a third battery cell 11 and a fourth battery cell 11 respectively adjacent to the two adjacent battery cells 11. It will be understood that, similar to this embodiment, in other embodiments, the supporting portion 22 may further extend toward both sides to cover the side portions 13 of more battery cells, thereby reducing the number of holders 20 in the battery pack 10.

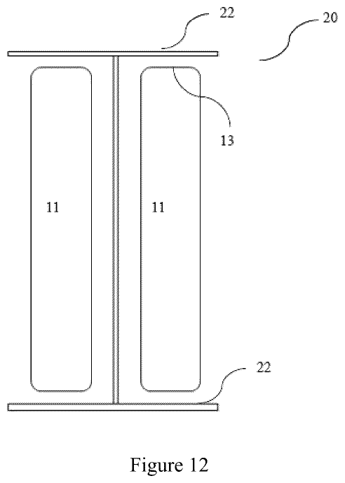

In addition, as shown in FIG. 12, in one or more embodiments, the holder 20 may also have an I-shaped cross-sectional shape in the width direction W. Specifically, the supporting portions 22 of the holder 20 extend from upper and lower ends of the main body portion 21 respectively, and the upper and lower supporting portions 22 are opposite to or abut against the two side portions 13 of the battery cell 11 respectively, thereby achieving stable fixation of the battery cell 11. Moreover, a groove and an adhesive overflow groove for accommodating adhesive is disposed on the outer surface of one or both of the two supporting portions 22. When the two supporting portions 22 enable the holder 20 to be bonded to the top cover and the cooling plate respectively via the adhesive, a stable integral structure is formed.

It should be understood that, on the premise of technical feasibility, the technical features listed above for different embodiments can be combined with each other to form other embodiments within the scope of the present disclosure.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises”, “comprising”, and “comprise”, respectively.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack, comprising:
a first battery cell;
a second battery cell; and
a holder having a main body portion that extends between opposite surfaces of the first battery cell and the second battery cell, and a supporting portion that extends from the main body portion to a side portion of the first battery cell, the second battery cell, or both,
wherein the supporting portion includes a groove extending on its outer surface.

2. The battery pack according to claim 1, wherein the first battery cell and the second battery cell respectively include a first surface and a second surface facing each other along a first direction, the first surface and the second surface are in contact with the main body portion, and the side portion of the first battery cell along a second direction is oriented opposite to or in contact with an inner surface of the supporting portion.

3. The battery pack according to claim 1, wherein the main body portion extends from a top of the first battery cell to a bottom of the first battery cell along a surface of the first battery cell.

4. The battery pack according to claim 3, wherein the main body portion is sheet-shaped, and the main body portion includes a plurality of notches or through openings.

5. The battery pack according to claim 1, wherein the supporting portion of the holder extends to cover side portions of the first battery cell and the second battery cell.

6. The battery pack according to claim 5, further comprising a third battery cell adjacent to the first battery cell, wherein the supporting portion extends to cover side portions of the first battery cell and the third battery cell.

7. The battery pack according to claim 1, further comprising:
a plurality of battery cells arranged along a first direction to form a battery module; and
a heat insulation plate at least partially covering an upper surface of the battery module, wherein the heat insulation plate is in contact with the supporting portion of the holder.

8. The battery pack according to claim 7, wherein a plurality of holders are provided, and a preset gap is formed between the supporting portions of adjacent holders.

9. The battery pack according to claim 7, wherein the supporting portion of the holder includes the groove and an adhesive overflow groove formed by a protrusion, and/or the groove and an adhesive overflow groove recessed from an upper surface of the supporting portion;
wherein the heat insulation plate includes an opening portion that is shaped to match the protrusion.

10. The battery pack according to claim 9, wherein the adhesive overflow groove is adjacent to the groove and extends along a direction of the groove.

11. The battery pack according to claim 7, further comprising a cooling plate disposed below one or more of battery modules, wherein the cooling plate is connected to a bridge bracket between adjacent battery modules, the bridge bracket has feet and a raised support body between the feet, and the feet are fixedly or detachably connected to a tray.

12. The battery pack according to claim 11, wherein the tray has an upper flange, a first side wall, and a first bottom wall;
the tray further includes a reinforcing bracket, the reinforcing bracket is connected to the upper flange and the first bottom wall at a distance from the first side wall, and the reinforcing bracket has a second side wall and a second bottom wall respectively having a first through-hole and a second through-hole.

13. The battery pack according to claim 12, further comprising:
an attachment bracket having connecting arms and an arched portion between the connecting arms;
wherein the attachment bracket is adjacent to the first through-hole and connected to the second side wall through the connecting arms; and wherein the first through-hole is oriented opposite to the arched portion to form a gap therebetween.

14. A vehicle having the battery pack of claim 1.

15. A battery holder, comprising:
a main body portion configured to extend on a first surface of a first battery cell;
a supporting portion extending from the main body portion; and
a groove extending along an upper surface of the supporting portion.

16. The battery holder according to claim 15, wherein the main body portion extends between the first surface of the first battery cell and a second surface of a second battery cell and is in contact with the first surface and the second surface, the first surface and the second surface are oppositely facing surfaces, and the supporting portion extends from the main body portion to a side portion of at least one battery cell, and the supporting portion has a lower surface that is oriented opposite to or in contact with a side portion of at least one of the first battery cell and the second battery cell.

17. The battery holder according to claim 15, wherein the main body portion is sheet-shaped, and the main body portion includes a plurality of notches or through openings.

18. The battery holder according to claim 14, wherein the supporting portion of the battery holder extends to cover side portions of at least two adjacent battery cells, and the battery holder has a T-shaped, L-shaped, or I-shaped cross-section.

19. The battery holder according to claim 15, wherein:
the supporting portion includes the groove and an adhesive overflow groove formed by a protrusion; and/or
the supporting portion includes the groove and an adhesive overflow groove recessed from the upper surface of the supporting portion.

20. The battery holder according to claim 19, wherein the adhesive overflow groove is adjacent to the groove and extends along a direction of the groove.
